(19) United States
(12) Patent Application Publication
(10) Pub. No.: US 2018/0287249 A1
(43) Pub. Date: Oct. 4, 2018

(54) ANTENNA APPARATUS AND ELECTRONIC DEVICE

(71) Applicant: FUJITSU LIMITED, Kawasaki-shi (JP)

(72) Inventors: Takashi YAMAGAJO, Yokosuka (JP); Yohei Koga, Kawasaki (JP); Manabu Kai, Yokohama (JP); Masatomo Mori, Kawasaki (JP); Tabito Tonooka, Kawasaki (JP); Mitsuharu Hoshino, Kawasaki (JP)

(73) Assignee: FUJITSU LIMITED, Kawasaki-shi (JP)

(21) Appl. No.: 15/913,561

(22) Filed: Mar. 6, 2018

(30) Foreign Application Priority Data
Mar. 29, 2017 (JP) 2017-065428

(51) Int. Cl. H01Q 1/32; H01Q 1/48; H01Q 21/06; H01Q 9/42; H01Q 21/00; H01Q 1/52

(52) U.S. Cl. CPC H01Q 1/3275; H01Q 1/48; H01Q 1/523; H01Q 9/42; H01Q 21/0025; H01Q 21/064

(57) ABSTRACT

An antenna apparatus includes: a ground plane having a slit extending from an edge to an inside first point and extending, along the edge, to a second point; a first antenna element having a first feed point and a first open end, the first feed point being arranged at an opposite side of an area surrounded by the slit and the edge with respect to the slit, the first antennae element extending from the first feed point to a first bend part at a first height position and extending to the first open end; and a second antenna element having a second feed point, arranged in the area, and a second open end, and extending from the second feed point to a second bend part at a second height position, extending to the second open end, and crossing, at a second open end side, the slit.

### CROSS-REFERENCE TO RELATED APPLICATION

This application is based upon and claims the benefit of priority of the prior Japanese Patent Application No. 2017-065428 filed on Mar. 29, 2017, the entire contents of which are incorporated herein by reference.

### FIELD

The embodiments discussed herein relate to an antenna apparatus and an electronic device.

### BACKGROUND

Conventionally, there exists an antenna device to be mounted for a vehicle that includes a substrate having a predetermined length in a horizontal direction and vertically-polarized antennas respectively provided on both end portions of the substrate in the horizontal direction.

The antenna device further includes patterns that are formed, for the respective antennas, on the substrate and that function as ground planes of the respective antennas; and an intermediate pattern that is formed on the substrate, is located between the patterns, and functions as a horizontally-polarized non-feed element for both of the respective antennas.

The antenna device further includes a phase control unit that controls a phase difference between reception signals of the antennas by changing at least one of the phases of reception signals of the respective antennas; and a combining unit configured to combine the reception signals after the phase control unit controls the phase difference.

The ground planes are separated from a circuit ground by respective slits formed on both end portions of the substrate (for example, see Patent Document 1).

Here, in the conventional antenna device, because the vertically-polarized antennas, which are arranged on both end portions of the substrate in the horizontal direction (antennae elements), are sufficiently away from each other, the coupling between the antenna elements does not become a problem.

For example, in a case where a space for arranging a plurality of antenna elements is limited, it is preferable to reduce coupling between the antenna elements.

### RELATED-ART DOCUMENTS

### Patent Documents

[Patent Document 1] Japanese Laid-open Patent Publication No. 2009-225133

### SUMMARY

According to an aspect of the embodiments, an antenna apparatus includes: a ground plane having an edge, a first surface; and a slit, the slit extending from a slit open end provided on the edge to an inside first point in plan view, the slit bending at the first point to extend, along the edge, to a second point; a first antenna element having a first feed point and a first open end, the first feed point being arranged, close to the first surface, at an opposite side of an area surrounded by the slit and the edge with respect to the slit in plan view, the first antenna element extending from the first feed point to a first bend part at a first height position with respect to the first surface, the first antenna element bending at the first bend part in a direction along the slit to extend to the first open end; and a second antenna element having a second feed point and a second open end, the second feed point being arranged, close to the first surface, in the area surrounded by the slit and the edge with respect to the slit in plan view, the second antenna element extending from the second feed point to a second bend part at a second height position with respect to the first surface, the second antenna element bending at the second bend part in the direction along the slit to extend to the second open end, the second antenna element crossing, at a second open end side, the slit in plan view.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a perspective view illustrating a front surface side of a tablet computer 500 including an antenna apparatus 100 according to a first embodiment;

FIG. 2 is a diagram illustrating a wiring substrate 505 of the tablet computer 500;

FIG. 3 is a perspective view illustrating the antenna apparatus 100 according to the first embodiment;

FIG. 4 is a plan view illustrating the antenna apparatus 100 according to the first embodiment;

FIG. 5 is a perspective view enlarging a part of FIG. 3;

FIG. 6 is a side view illustrating the enlarged part illustrated in FIG. 5;

FIG. 7 is a diagram illustrating each parameter of a simulation model of the antenna apparatus 100;

FIG. 8 is a diagram illustrating frequency characteristics of a coupling factor between the antenna elements 110 arm 120 obtained by the simulation model that is illustrated in FIG. 7;

FIGS. 9A and 9B are diagrams illustrating electric current distributions of a ground plane 50, a slit 55, a frame part 56, and the antenna elements 110 and 120;

FIG. 10 is a perspective view illustrating an antenna apparatus 200 according to a second embodiment;

FIG. 11 is a perspective view enlarging a part of FIG. 10;

FIG. 12 is a diagram illustrating each parameter of a simulation model of the antenna apparatus 200;

FIG. 13 is a diagram illustrating frequency characteristics of a coupling factor between the antenna elements 110 and 120 obtained by the simulation model that is illustrated in FIG. 12;

FIG. 14 is a diagram illustrating an antenna apparatus 200A according to a variation example of the second embodiment;

FIG. 15 is a diagram illustrating an antenna apparatus 200B according to a variation example of the second embodiment;

FIG. 16 is a perspective view illustrating an antenna apparatus 300 according to a third embodiment;

FIG. 17 is a plan view illustrating the antenna apparatus 300 according to the third embodiment;

FIG. 18 is a perspective view enlarging a part of FIG. 16;

FIG. 19 is a plan view illustrating the enlarged part illustrated in FIG. 18;

FIG. 20 is a diagram illustrating each parameter of a simulation model of the antenna apparatus 300;

FIG. 21 is a diagram illustrating frequency characteristics of a coupling factor between the antenna elements 110 and 120 obtained by the simulation model that is illustrated in FIG. 20;

FIG. 22 is a diagram illustrating frequency characteristics of a coupling factor between the antenna elements 110 and 120 and reflection coefficients of the antenna elements 110 and 120 obtained by the simulation model that is illustrated in FIG. 20; and

FIG. 23 is a diagram illustrating frequency characteristics of total efficiencies of the antenna elements 110 and 120 obtained by the simulation model that is illustrated in FIG. 20.

### DESCRIPTION OF EMBODIMENT

Hereinafter, embodiments to which an antenna apparatus and an electronic device of the present invention are applied will be described. An object in one aspect of the embodiments is to provide an antenna apparatus and an electronic device in which the coupling between antenna elements is reduced.

### First Embodiment

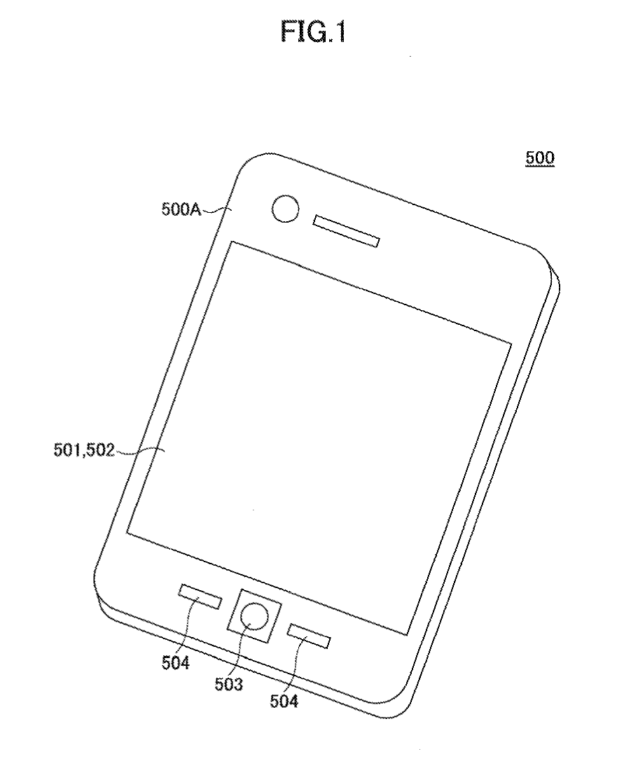

FIG. 1 is a perspective view illustrating a front surface side of a tablet computer 500 including an antenna apparatus according to a first embodiment. The tablet computer 500 is an example of an electronic device including an antenna apparatus according to the first embodiment.

A touch panel 501 and a display panel 502 are disposed at the front surface side of a housing 500A of the tablet computer 500. A home button 503 and switches 504 are disposed below the touch panel 501. The touch panel 501 is provided at the display surface side of the display panel 502.

Note that an electronic device including an antenna apparatus according to the first embodiment is not limited to the tablet computer 500, but may be a smartphone terminal device, a portable phone terminal device, a game machine, or the like,

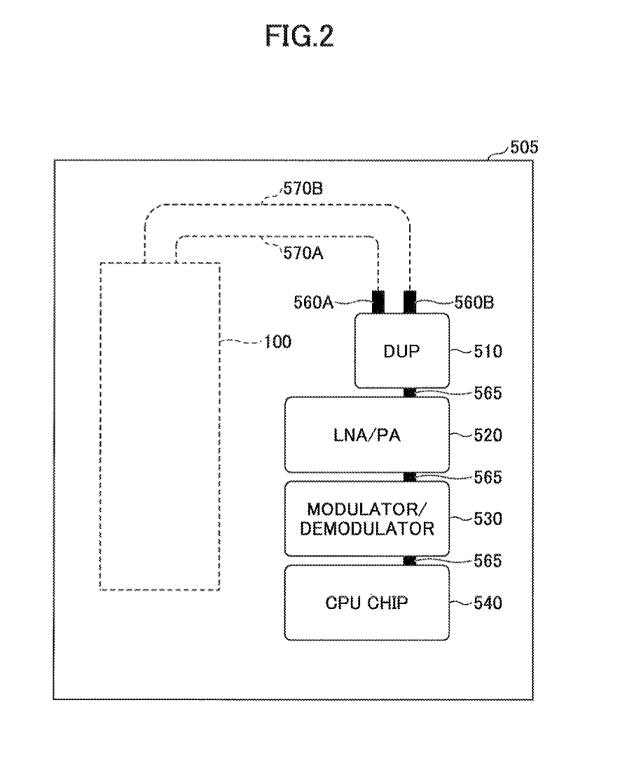

FIG. 2 is a diagram illustrating a wiring substrate 505 of the tablet computer 500.

The wiring substrate 505 is disposed inside the housing 500A (see FIG. 1). On the wiring substrate 505, a Duplexer (DUP) 510, a Low Noise Amplifier/Power Amplifier (LNA/PA) 520, a modulator/demodulator 530, and a Central Processing Unit (CPU) chip 540 are mounted.

Further, on a surface opposite to a surface of the wiring substrate 505 on which the DUP 510, the LNA/PA 520, the modulator/demodulator 530, and the CPU chip 540 are mounted, the antenna apparatus 100 according to the first embodiment is disposed. As details of the configuration of the antenna apparatus 100 will be described later below, the position of the antenna apparatus 100 is illustrated by the broken line in FIG. 2.

The DUP 510, the LNA/PA 520, the modulator/demodulator 530, and the CPU chip 540 are connected through a wire 565.

The DUP 510 is connected to two antenna elements of the antenna apparatus 100 from wires 560A and 560B through a non-illustrated via and coaxial cables 570A and 570B, which are provided on the opposite side of the wiring substrate 505, and switches transmission or reception. Because the DUP 510 includes a function as a filter, in a case where the antenna apparatus 100 receives a plurality of signals of frequencies, the DUP 510 can isolate the respective signals of the frequencies inside the antenna apparatus 100.

The LNA/PA 520 amplifies electric power of a transmission wave and a reception wave. The modulator/demodulator 530 modulates the transmission wave and demodulates the reception wave. The CPU chip 540 includes a function as a communication processor that performs a communication process of the tablet computer 500 and a function as an application processor that executes an application program. Note that the CPU chip 540 includes an internal memory that stores data such as data to be transmitted and received data.

Note that the wires 560A, 560B, and 565 are formed by patterning a copper foil at a surface of the wiring substrate 505, for example. Further, matching circuits (not illustrated in FIG. 2) are provided between the antenna apparatus 100 and the DUP 510 for adjusting impedance characteristics.

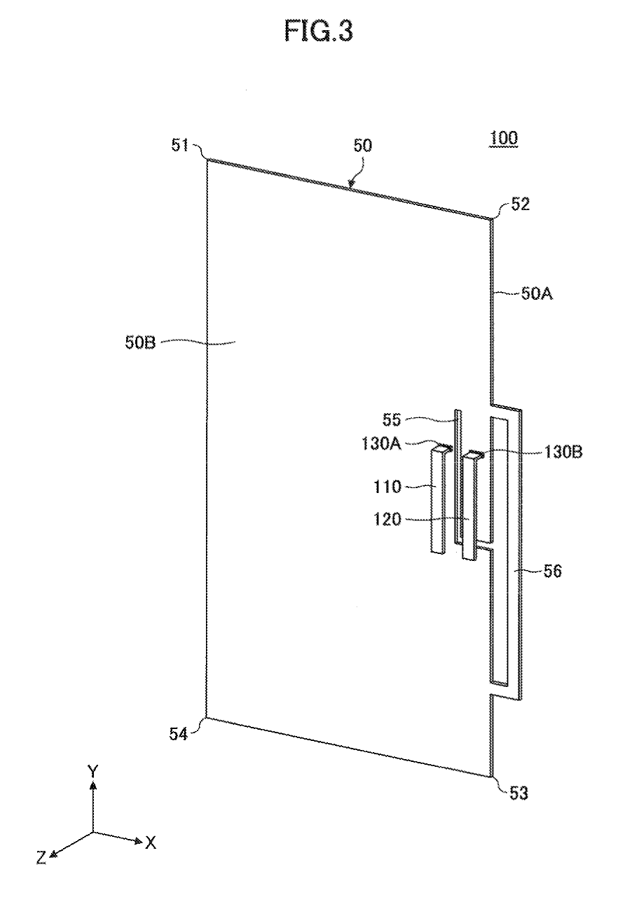

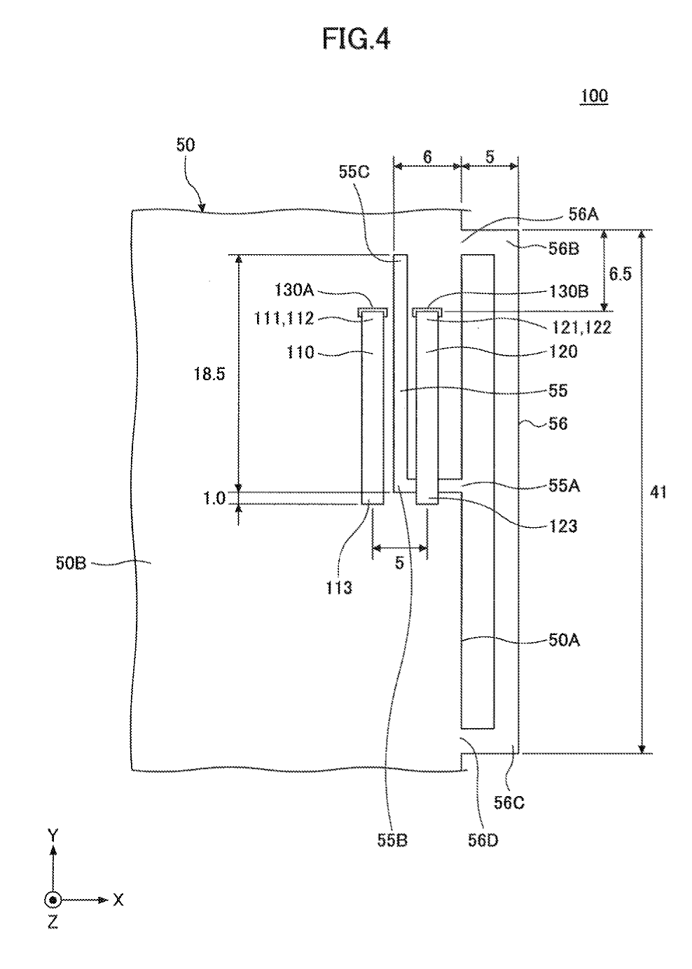

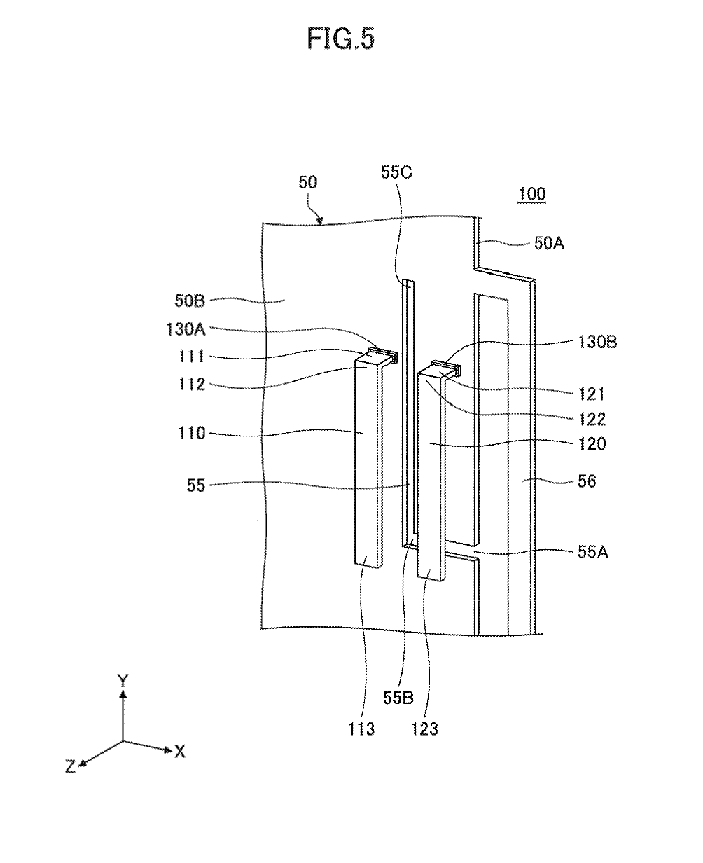

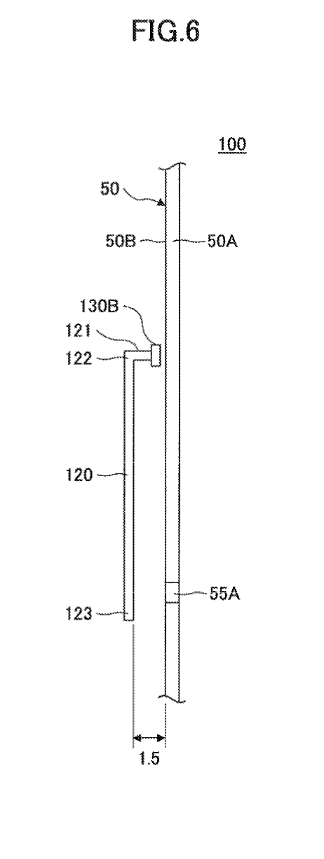

FIG. 3 and FIG. 4 are a perspective view and a plan view illustrating the antenna apparatus 100 according to the first embodiment. FIG. 5 is a perspective view enlarging a part of FIG. 3, and FIG. 6 is a side view illustrating the enlarged part illustrated in FIG. 5.

The antenna apparatus 100 includes a ground plane 20, antenna elements 110 and 120, and matching circuits 130A and 130B. The antenna apparatus 100 is provided in the tablet computer 500 (see FIG. 1) that has a communication function.

The ground plane 50 is a metal layer that is held at a ground potential and is a rectangular metal layer having vertices 51, 52, 53, and 54. The ground plane 50 can be treated as a ground plate.

For example, the ground plane 50 is a metal layer that is arranged on the front surface, on the back surface, or in an inside layer of the FR-4 (Flame Retardant type 4) wiring substrate 505 (see FIG. 2). Here, for example, the ground plane 50 is arranged on the surface opposite to the surface on which the DUP 510, the LNA/PA 520, the modulator/demodulator 530, the CPU chip 540, and the wires 560A, 560B, and 565 of the wiring substrate 505 are mounted.

Although FIG. 3 illustrates the ground plane 50 having linear edges between the vertices 51 and 52, the vertices 53 and 54, and the vertices 54 and 51, the edges may be non-linear in a case where a protrusion/recess is provided in accordance with an internal shape or the like of a housing of an electronic device including the antenna apparatus 100, for example. Note that in the following, the side between the vertices 52 and 53 of the ground plane 50 is referred to as the edge 50A.

Further, the ground plane 50 includes a slit 55 and a frame part 56. Antenna elements 110 and 120 are provided on the positive side in the Z axis direction with respect to the surface 50B of the ground plane 50. The surface 50B is an example of a first surface.

The slit 55 is an L-shaped slit in plan view having an open end 55A, a bend part 55B, and an end part 55C. The slit 55 extends from the open end 55A, provided on the edge 50A, to the bend part 55B at the negative side in the X axis direction, and bends at the bend part 55B towards the positive side in the Y axis direction, to extend to the end part 55C. The position of the open end 55A in the Y axis direction of is substantially the center of the edge 50A. The open end 55A is an example of a slit open end, the bend part 55B is an example of a first point, and the end part 55C is an example of a second point.

The slit 55 is a cut part obtained by cutting an L-shaped portion, of the ground plane 50, from the open end 55A to the end part 55C via the bend part 55B. Such a slit 55 can be formed by patterning the ground plane 50 of the wiring substrate 505 using an etching process or the like, for example.

The frame part 56 is provided to protrude towards the positive side in the X axis direction from the edge 50A of the ground plane 50. The frame part 56 includes a connection end 56A, bend parts 56B and 56C, and a connection end 56D. The frame part 56 is held at a ground potential similar to the ground plane 50.

The connection end 56A of the frame part 56 is connected to the edge 50A. The frame part 56 extends, towards the positive side in the X axis direction, from the connection end 56A to the bend part 56B, bends at the bend part 56B towards the negative side in the X axis direction to extend from the bend part 56B to the bend part 560, and bends at the bend part 56C towards the negative side in the X axis direction to extend from the bend part 56C to the connection end 56D. The connection end 56D is connected to the edge 50A. The frame part 55 is a frame-shaped metal member that protrudes towards the positive side in the X axis direction from the edge 50A of the ground plane 50.

The frame part 56 is an example of a protruding metal member, the connection end 56A is an example of a first end part, the bend part 56B and the bend part 56C are respectively examples of a third bend part and a fourth bend part, and the connection end 56D is an example of a second end part. Further, a section between the connection end 56A and the bend part 56B is an example of a first section, a section between the bend parts 56B and 56C is an example of a second section, and a section between the bend part 56C and the connection end 56D is an example of a third section.

Note that because the slit 55 is coupled with the antenna element 120 to operate integrally, the length from the open end 55A through the bend part 55B to the end part 55C is set to be a quarter wavelength of a wavelength at a communication frequency.

In addition, because a rectangular loop that is formed by the frame part 56 and the edge 50A is coupled with the antenna element 120 to integrally operate, the length of the loop is set to be one wavelength at the communication frequency.

In order to expand the frequency band of the antenna element 120, the length of the slit 55 may be shorter than the quarter wavelength and the length of the loop formed by the frame part 56 and the edge 50A may be longer than the one wavelength. Conversely, in order to expand the frequency band of the antenna element 120, the length of the slit 55 may be longer than the quarter wavelength and the length of the loop formed by the frame part 56 and the edge 50A may be shorter than the one wavelength.

The antenna element 110 includes a feed point 111, a bend part 112, and an open end 113, and is arranged close to the surface 50B of the ground plane 50. The antenna element 110 is an inverted-L antenna element having and is an example of a first antenna element. The antenna element 110 is, for example, fixed to an inner surface of the housing 500A (see FIG. 1).

On the negative side in the X axis direction with respect to the section between the bend part 55B and the end part 55C of the slit 55, the feed point 111 is provided to be separated from the surface 50B of the ground plane 50 but close to the surface 50B.

A coaxial cable 570A is connected to the feed point 111 via a matching circuit 130A. The feed point 111 is connected to the core wire of the coaxial cable 570A (see FIG. 2) via the matching circuit 130A and is supplied with power.

The antenna element 110 extends from the feed point 111 towards the positive side in the Z axis direction, and bends, at the bend part 112, towards the negative side in the Y axis direction to extend from the bend part 112 to the open end 113. The section between the bend part 112 and the open end 113 is along and is arranged parallel to the section between the bend part 55B and the end part 55C of the slit 55.

Also, the height (the distance in the Z axis direction) from the surface 50B of the ground plane 50 in the section between the bend part 112 and the open end 113 is constant. In plan view, the position of the open end 113 is on the negative side in the Y axis direction with respect to the bend part 55B and the open end 55A of the slit 55, for example.

The bend part 112 is an example of a first bend part, the height of the bend part 112 from the surface 50B of the ground plane 50 is an example of a first height position, and the open end 113 is an example of a first open end.

Such an antenna element 110 is arranged, close to the surface 50B of the ground plane 50, at the opposite side of an area surrounded by the slit 55 and the edge 50A with respect to the slit 55.

The length of the antenna element 110 from the feed point 111 to the open end 113 via the bend part 112 is set to be a quarter of an electrical wavelength (λ) at a communication frequency in consideration of a reduction effect of the wavelength due to the matching circuit 130A.

The antenna element 120 includes a feed point 121, a bend part 122, and an open end 123, and is arranged close to the surface SOB of the ground plane 50, The antenna element 120 is an inverted-L antenna element and is an example of a second antenna element. The antenna element 120 is, for example, fixed to the inner surface of the housing 500A (see FIG. 1).

The feed point 121 is provided on the positive side in the X axis direction with respect to the section between the bend part 55B and the end part 55C of the slit 55. A coaxial cable 570B is connected to the feed point 121 via a matching circuit 130B. The position of the feed point 121 is a position line-symmetric with the feed point 111 with respect to a line-symmetric axis (axis parallel to the Y axis) passing through the center of the width in the X axis direction of the section between the bend part 55B and the end part 550 of the slit 55. The feed point 121 is connected to the core wire of the coaxial cable 570B (see FIG. 2) via the matching circuit 130B and is supplied with power.

The antenna element 120 extends from the feed point 121 towards the positive side in the Z axis direction, and bends, at the bend part 122, towards the negative side in the Y axis direction to extend from the bend part 122 to the open end 123. The section between the bend part 122 and the open end 123 is along and is arranged parallel to the section between the bend part 55B and the end part 55C of the slit 55.

Also, the height (the distance in the Z axis direction) from the surface 50B of the ground plane 50 in the section between the bend part 122 and the open, end 123 is constant. The height of the bend part 122 is equal to the height of the bend part 112.

In plan view, the position of the open end 123 is on the negative side in the Y axis direction with respect to the bend part 55B and the open end 55A of the slit 55, for example. Hence, a portion of the second antenna element 120 at the open end 123 side crosses the section between the open end 55A and the bend part 55B of the slit 55. Note that the position of the open end 123 in the Y axis direction is equal to the position of the open end 113 in the Y axis direction.

In order to reduce the coupling between the antenna elements 120 and 110 by coupling the antenna element 120 with the slit 55, the portion of the second antenna element 120 at the open end 123 side is caused to cross the slit 55 in this way.

The bend part 122 is an example of a second bend part, the height of the bend part 122 from the surface 50B of the ground plane 50 is an example of a second height position, and the open end 123 is an example of a second open end.

Such an antenna element 120 is arranged, close to the surface 50B of the ground plane 50, with respect to the area surrounded by the slit 55 and the edge 50A with respect to the slit 55.

The length of the antenna element 120 from the feed point 121 to the open end 123 via the bend part 122 is set to be a quarter of an electrical wavelength (λ) at a communication frequency in consideration of a reduction effect of the wavelength due to the matching circuit 130B.

The matching circuit 130A is connected between the feed point 111, the coaxial cable 570A, and the ground plane 50. The matching circuit 130A includes an inductor and/or a capacitor, and is provided for impedance matching between the feed point 111, the coaxial cable 570A, and the ground plane 50.

The matching circuit 130B is connected between the feed point 121, the coaxial cable 570B, and the ground plane 50. The matching circuit 130B includes an inductor and/or a capacitor, and is provided for impedance matching between the feed point 121, the coaxial cable 570B, and the ground plane 50.

Note that the dimensions of each part are as follows, for example. The dimensions described here are on the basis that the antenna elements 110 and 120 perform communication at 3.5 GHz.

As illustrated in FIG. 4, the length of the slit 55 from the bend part 55B to the end part 55C is 18.5 mm. The interval from the edge 50A to the negative side end of the end part 55C of the slit 55 in the X axis direction is 6 mm. The length of the frame part 56 from the connection end 56A to the bend part 56B is 5 mm. The interval in the Y axis direction, from the positive side end in the Y axis direction of the bend part 56B of the frame part 56 to the feed point 121 of the antenna element 120, is 6.5 mm.

The interval between the center of the width of the antenna element 110 and the center of the width of the antenna element 120 in the X axis direction is 5 mm. The length in the Y axis direction from the negative side end in the Y axis direction of the section between the open end 55A and the bend part 55B of the slit 55 to the open end 123 of the antenna element 120 is 1.0 mm. Further, as illustrated in FIG. 6, the height of the antenna element 120 from the surface 50B of the ground plane 50 is 1.5 mm.

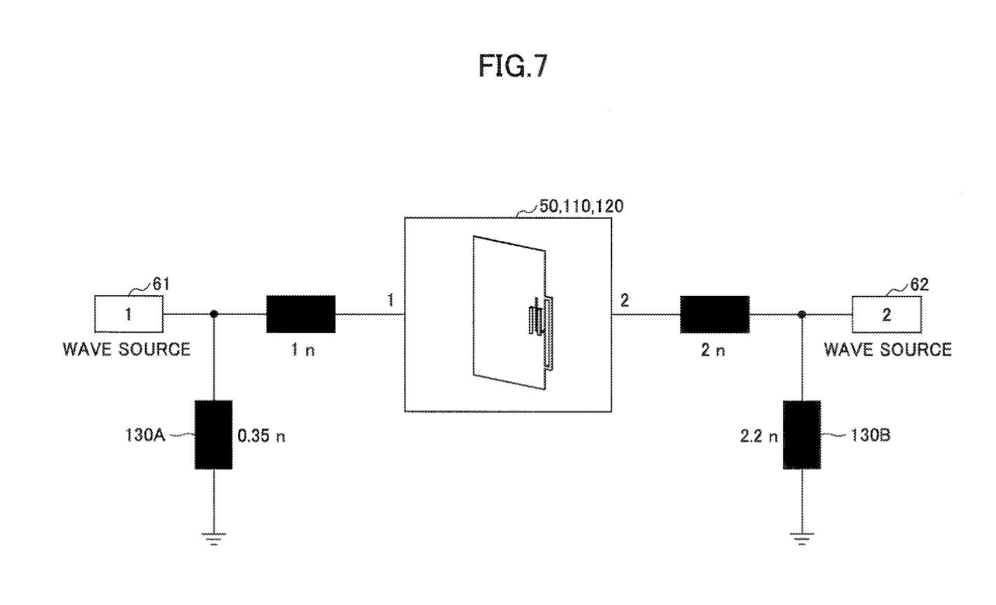

FIG. 7 is a diagram illustrating each parameter of a simulation model of the antenna apparatus 100. In FIG. 7, the ground plane 50 and the antenna elements 110 and 120 are simplified and illustrated as one block. Ports 1 and 2 are the feed points 111 and 121, respectively. Further, FIG. 7 illustrates inductors of the matching circuits 130A and 130B. Further, the wave sources 61 and 62 are high-frequency sources that supply high-frequency electric power to the feed points 111 and 121 (ports 1 and 2), and the internal impedances are both 50 Ω.

Further, in the simulation model, the ground plane 50 is conditioned to infinitely extend in three side directions (which are the negative X axis direction, the positive Y axis direction, and the negative Y axis direction) except the edge 50A. Further, in the simulation model, conductors such as the ground plane 50, the antenna elements 110 and 120 are perfect conductors.

The matching circuit 130A is sec to include an inductance (1 nH) that is inserted between the feed point 111 and the wave source 61 and an inductance (0.35 nH) that is inserted between the ground plane 50 and a point branched from between the feed point 111 and the wave source 61.

Further, the matching circuit 130B is set to include an inductance (2 nH) that is inserted, between the feed point 121 and the wave source 62 and an inductance (2.2 nH) that is inserted between the ground plane 50 and a point branched from between the feed point 121 and the wave source 62.

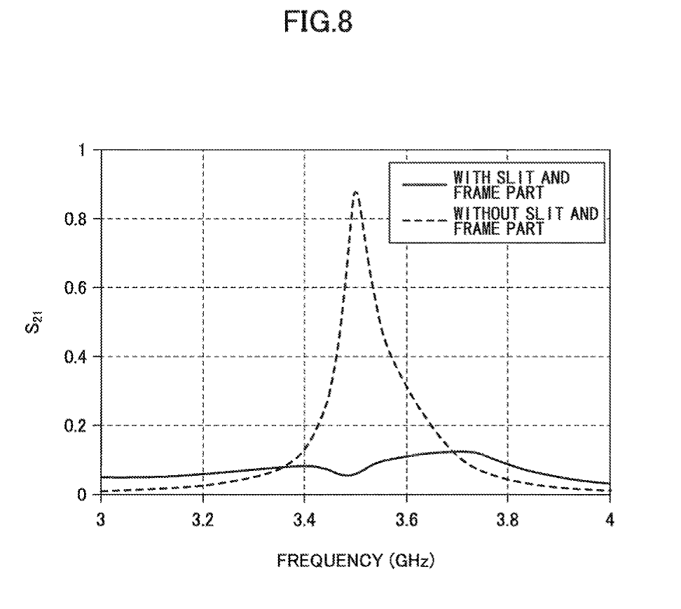

FIG. 8 is a diagram illustrating frequency characteristics of a coupling factor between the antenna elements 110 and 120 obtained by the simulation model that is illustrated in FIG. 7. The coupling factor between the antenna elements 110 and 120 is a S₂₁ parameter.

In FIG. 8, the horizontal axis represents the frequency and the vertical axis represents the value of the S₂₁ parameter (true value). Further, here, a coupling factor between antenna elements 110 and 120 in a simulation model without a slit 55 and a frame part 56 is also obtained for comparison. Note that the communication frequency of the antenna elements 110 and 120 (resonant frequency) is 3.5 GHz, for example.

In FIG. 8, as illustrated by the solid line, the coupling factor between the antenna elements 110 and 120 of the simulation model that includes the slit 55 and the frame part 56 is approximately 0.06 at 3.5 GHz, and as illustrated by the broken line, the coupling factor between the antenna elements 110 and 120 of the simulation model that does not include the slit 55 and the frame part 56 is approximately 0.87 at 3.5 GHz. Thus, it is found that the coupling factor is significantly reduced by providing the slit 55 and the frame part 56 on the ground plane 50 and forming the rectangular loop by the frame part 56 and the edge 50A of the ground plane 50.

That is, it is found that the coupling factor between the antenna elements 110 and 120 that are arranged side by side can be significantly reduced by providing the slit 55 and the frame part 56 that are coupled to the antenna element 120.

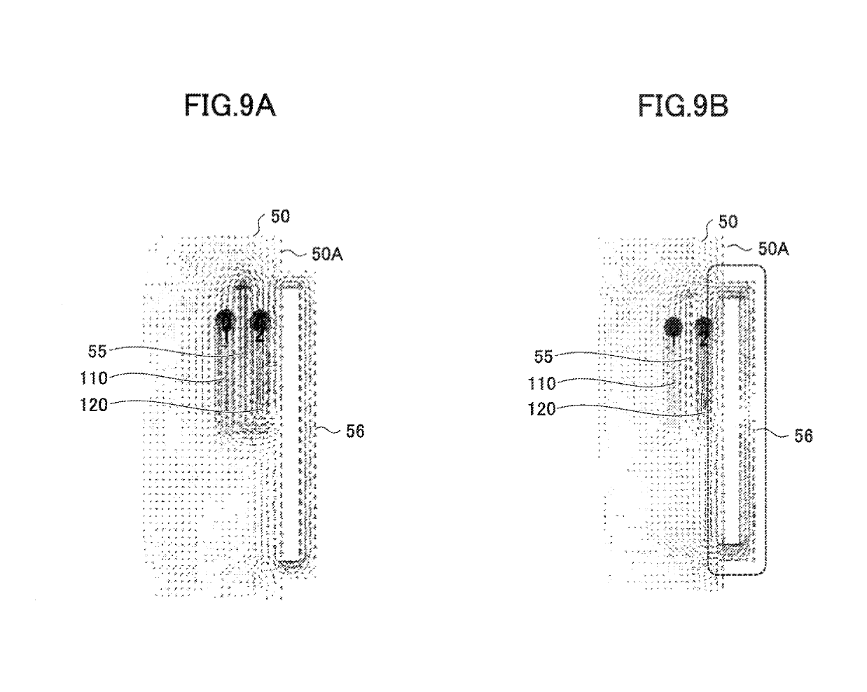

FIGS. 9A and 9B are diagrams illustrating electric current distributions of the ground plane 50, the slit 55, the frame part 56, and the antenna elements 110 and 120. The electric current distribution is obtained in an electromagnetic field simulation under a condition that power is supplied only to the antenna element 120 without feeding power to the antenna element 110.

FIGS. 9A and 9B illustrate the electric current distributions at timings for which phases of a high-frequency of 3.5 GHz differ from each other. The darker the arrow, the higher the current density, and the thinner the arrow, the lower the current density. Further, the feed points 111 and 121 are illustrated as the ports 1 and 2.

In FIG. 9A, it is found that the antenna element 120 and the slit 55 operate integrally and an electric current flows. Further, it is found that the current density is low at the open end 55A of the slit 55 and the current density is high at the end part 55C. Thus, it is found that in the slit 55, resonance of a quarter wavelength of the wavelength at the communication frequency occurs. Further, it can be confirmed that an electric current also flows in the frame part 55.

Further, in FIG. 9B, as can be seen from a portion enclosed by the broken line, it is found that the current density is high at the feed point 121 side of the antenna element 120, at the connection end 56A and the bend part 56B of the frame part 56, and at the connection end 56D and the bend part 56C of the frame part 56. Further, it is found that almost no electric current flows in the antenna element 110.

Thus, it can be confirmed that the coupling between the antenna elements 110 and 120 is reduced and that an electric current also flows in the frame part 56. It can be confirmed that resonance of one wavelength of the wavelength at the communication frequency occurs in the rectangular loop that is formed by the frame part 56 and the edge 50A. Further, it can be confirmed that the antenna element 110 operates alone independently from the antenna element 120.

As described above, according to the first embodiment, the coupling between the antenna elements 110 and 120 that are arranged side by side can be reduced by providing the slit 55 formed into a L shape from the edge 50A of the ground plane 50, respectively arranging the antenna elements 110 and 120 on both sides with respect to the slit 55, and causing the open end 123 side of the antenna element 120 to cross over the slit 55.

Therefore, it is possible to provide the antenna apparatus 100 and the tablet computer 500 in which the coupling between the antenna elements 110 and 120 is reduced. For example, the antenna elements 110 and 120 can be used for multiple-input and multiple-output (MIMO) method communication.

Further, by providing the frame part 56 on the ground plane 50, an electric current flows in the rectangular loop that is formed by the frame part 56 and the edge 50A. Thereby, it is possible to cause a large amount of electric current to flow in the antenna element 120. This also allows to reduce the coupling between the antenna elements 110 and 120.

In a case where a space for arranging the antenna elements 110 and 120 is limited as in the tablet computer 500, arranging the antenna elements 110 and 120 side by side is efficient for allocating an inside space of the housing 500A of the tablet computer 500 to various components.

Further, when power is fed from the DUP 510 (see FIG. 2) through the coaxial cables 570A and 570B, the lengths of the coaxial cables 570A and 570B can be shortened by arranging the antenna elements 110 and 120 side by side. For example, in a case where two antenna elements are arranged at the positive side end part of the ground plane 50 in the X axis direction and the negative side end part of the ground plane 50 in the X axis direction, the coupling between the antenna elements is low but lengths of coaxial cables connected to the respective antenna elements are long.

In the antenna apparatus 100, the antenna elements 110 and 120 are arranged side by side, the slit 55 is interposed between the antenna elements 110 and 120, and the open end 123 side of the antenna element 120 is caused to cross over the slit 55. Thereby, the coupling between the antenna elements 110 and 120 can be reduced, a use efficiency of a space can be improved, and the lengths and arrangement of the coaxial cables 570A and 570B can be shortened and simplified.

Although the two antenna elements 110 and 120 are provided at the ground plane 50 in the embodiment described above, antenna elements may be further provided respectively at a positive side end part in the Y axis direction of the ground plane 50 and a negative side end part in the Y axis direction of the ground plane 50. According to such a configuration, the antenna apparatus 100 includes four antenna elements and, it is possible to realize, for example, 4×4 MIMO method communication. Because the two antenna elements disposed at the positive side end part and the negative side end part in the Y axis direction of the ground plane 50 are sufficiently away from the antenna elements 110 and 120, such a configuration is considered to not cause a problem of coupling.

Note that although the antenna elements 110 and 120 are inverted-L antenna elements in the embodiment described above, the antenna elements 110 and 120 may be inverted-F antenna elements.

Further, in the embodiment described above, the connection end 56A and the bend part 56B of the frame part 56 are located on the positive side in the Y axis direction with respect to the end part 55C of the slit 55. However, the connection end 56A and the bend part 56B of the frame part 56 may be located at positions equal to that of the end part 55C of the slit 55 in the Y axis direction, or the connection end 56A and the bend part 56B of the frame part 56 may be located on the negative side in the Y axis direction with respect to the end part 55C of the slit 55.

Further, in the embodiment described above, the connection end 56A and the bend part 56B of the frame part 56 are located on the positive side in the Y axis direction with respect to the feed point 121 of the antenna element 120. However, the connection end 56A and the bend part 56B of the frame part 56 may be located at positions equal to that of the feed point 121 in the Y axis direction, or the connection end 56A and the bend part 56B of the frame part 56 may be located on the negative side in the Y axis direction with respect to the feed point 121.

Also, the positions of the connection end 56D and the bend part 56C of the frame part 56 may be positions that are closer to the open end 55A than the positions that are illustrated in FIG. 3 and FIG. 4 are. The positions of the antenna elements 110 and 120 may differ from each other in the Y axis direction.

Further, although the feed point 111 is located between the bend part 55B and the end part 55C of the slit 55 in the Y axis direction in the embodiment described above, the feed point 111 may be located on the positive side in the Y axis direction with respect to the bend part 55B of the slit 55. Similarly, in the Y axis direction, the feed point 121 may be located on the positive side in the Y axis direction with respect to the bend part 55B of the slit 55.

### Second Embodiment

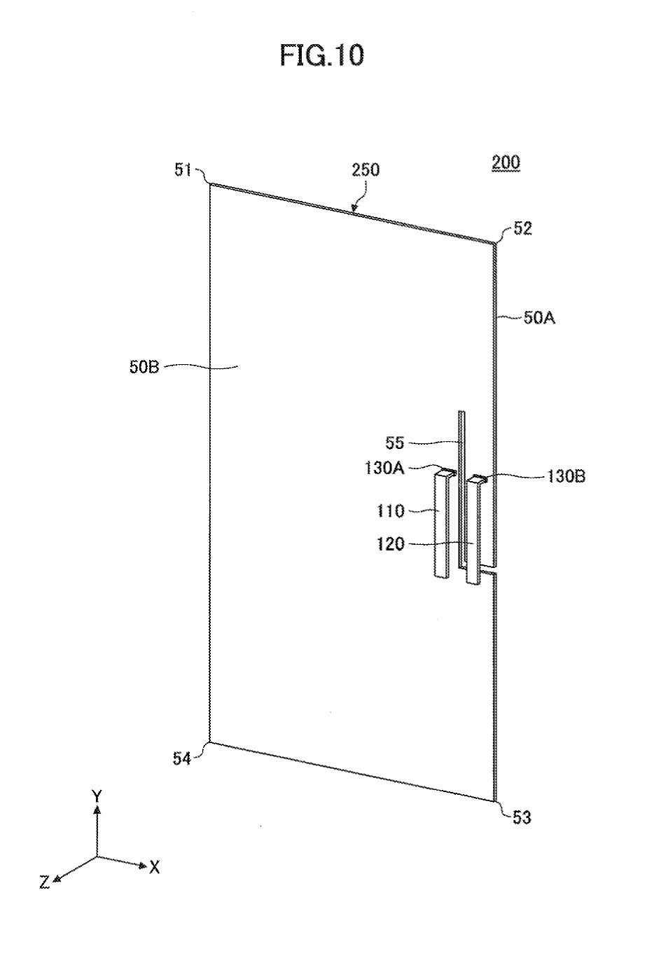

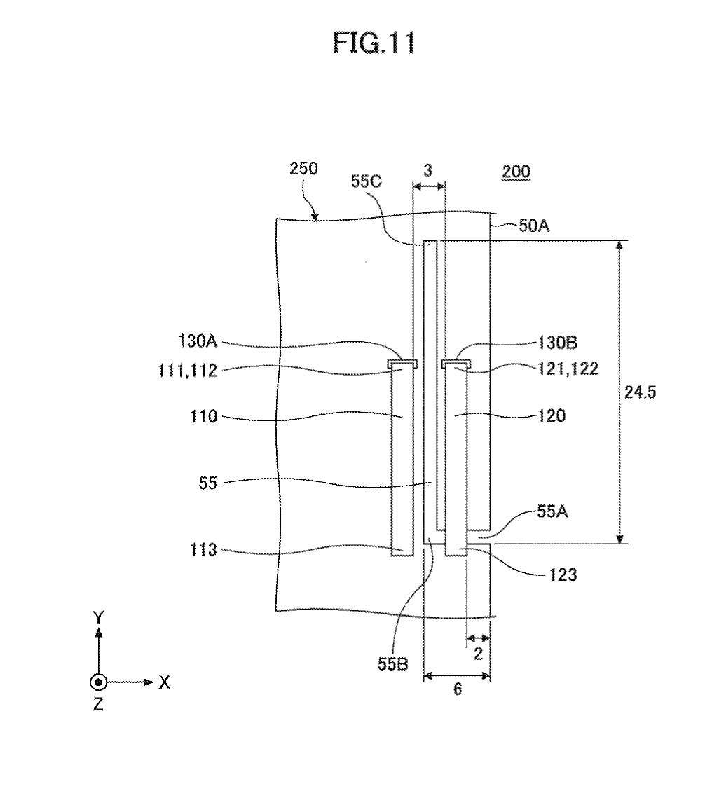

FIG. 10 is a perspective view illustrating art antenna apparatus 200 according to a second embodiment. FIG. 11 is a plan view enlarging a part of FIG. 10.

The antenna apparatus 200 includes a ground plane 250, antenna elements 110 and 120, and matching circuits 130A and 130B. The antenna apparatus 200 has a configuration obtained by replacing the ground plane 50 of the antenna apparatus 100 of the first embodiment with the ground plane 250. The ground plane 250 is obtained by removing the frame part 56 from the ground plane 50 of the first embodiment. Because other components of the antenna apparatus 200 are similar to those of the antenna apparatus 100 of the first embodiment, the same reference numerals are given to the similar components and their descriptions are omitted as appropriate.

Note that the dimensions of each part are as follows, for example. The dimensions described here are on the basis that the antenna elements 110 and 120 perform communication at 3.5 GHz.

The length of the slit 55 from the bend part 55B to the end part 55C is 24.5 mm. The interval from the negative side end in the X axis direction of the section between the bend, part 55B and the end part 55C of the slit 55 to the edge 50A is 6 mm. The interval from the edge 50A to the positive side end in the X axis direction of the section between the bend part 122 and the open end 123 of the antenna element 120 is 2 mm. Other lengths and intervals of the antenna apparatus 200 are similar to those in the first embodiment.

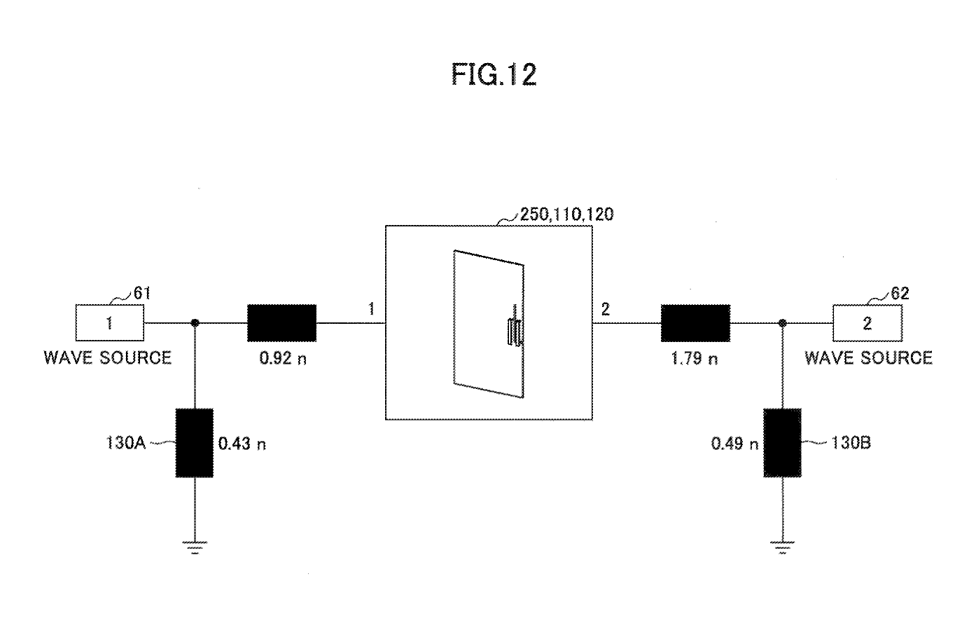

FIG. 12 is a diagram illustrating each parameter of a simulation model of the antenna apparatus 200. In FIG. 12, the ground plane 250 and the antenna elements 110 and 120 are simplified and illustrated as one block. Other configurations are similar to those in FIG. 7.

The matching circuit 130A is set to include an inductance (0.92 nH) that is inserted between the feed point 111 and the wave source 61 and an inductance (0.43 nH) that is inserted between the ground plane 250 and a point branched from between the feed point 111 and the wave source 61.

Further, the matching circuit 130B is set to include an inductance (1.79 nH) that is inserted between the feed point 121 and the wave source 62 and an inductance (0.49 nH) that is inserted between the ground plane 250 and a point branched from between the feed point 121 and the wave source 62.

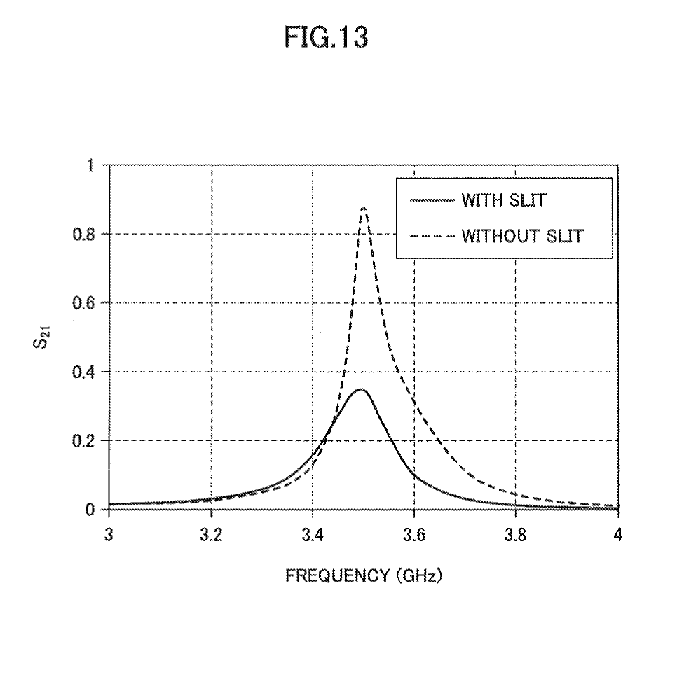

FIG. 13 is a diagram illustrating frequency characteristics of a coupling factor between the antenna elements 110 and 120 obtained by the simulation model that is illustrated in FIG. 12, The coupling factor between the antenna elements 110 and 120 is a S₂₁ parameter.

In FIG. 13, the horizontal axis represents the frequency and the vertical axis represents the value of the S₂₁ parameter (true value). Further, here, a coupling factor between antenna elements 110 and 120 in a simulation model without a slit 55 is also obtained for comparison. Note that the communication frequency of the antenna elements 110 and 120 (resonant frequency) is 3.5 GHz, for example.

In FIG. 13, as illustrated by the solid line, the coupling factor between the antenna elements 110 and 120 of the simulation model that includes the slit 55 is approximately 0.35 at 3.5 GHz, and as illustrated by the broken line, the coupling factor between the antenna elements 110 and 120 of the simulation model that does not include the slit 55 is approximately 0.87 at 3.5 GHz.

Thus, it is found that the coupling factor is significantly reduced by providing the slit 55 on the ground plane 250, which does not include the frame part 56. It is found that although the reduction degree of the coupling between the antenna elements 110 and 120 is slightly smaller than that of the simulation model including the ground plane 50 of the first embodiment including the frame part 56, the coupling between the antenna elements 110 and 120 is sufficiently reduced.

As described above, according to the second embodiment, the coupling between the antenna elements 110 and 120 that are arranged side by side can be reduced by providing the slit 55 formed into a L shape from the edge 50A of the ground plane 250, respectively arranging the antenna elements 110 and 120 on both sides with respect to the slit 55, and causing the open end 123 side of the antenna element 120 to cross over the slit 55.

Therefore, it is possible to provide the antenna apparatus 200 and the tablet computer 500 in which the coupling between the antenna elements 110 and 120 is reduced.

Further, similar to the antenna apparatus 100 according to the first embodiment, in the antenna apparatus 200, the antenna elements 110 and 120 are arranged side by side, the slit 55 is provided between the antenna elements 110 and 120, and the open end 123 side of the antenna element 120 is caused to cross over the slit 55. Thereby, the coupling between the antenna elements 110 and 120 can be reduced, a use efficiency of a space can be improved, and the lengths and arrangement of the coaxial, cables 570A and 570B can be shortened and simplified.

Further, although the antenna elements 110 and 120 are provided on both sides with respect to the slit 55 and the antenna elements 110 and 120 are provided side by side in parallel in the embodiment described above, the arrangement may be changed as follows.

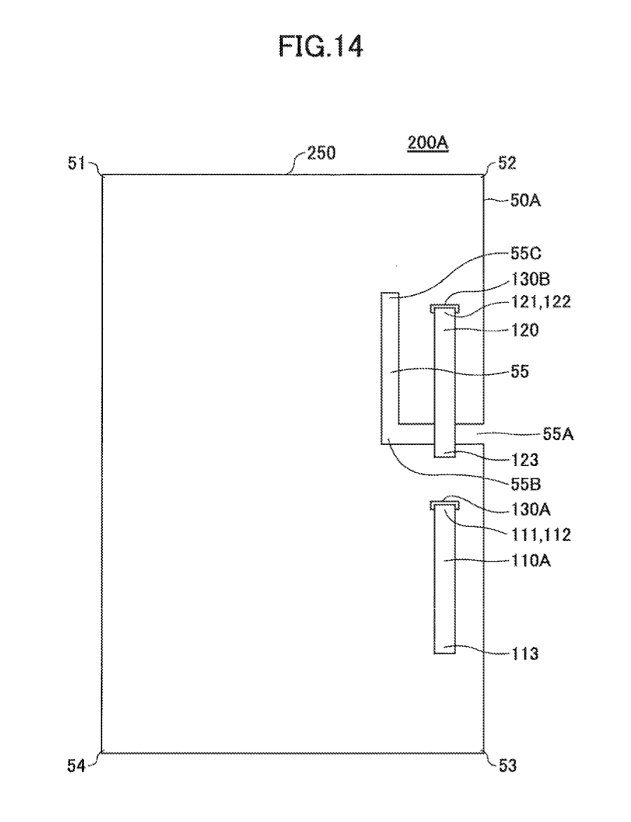

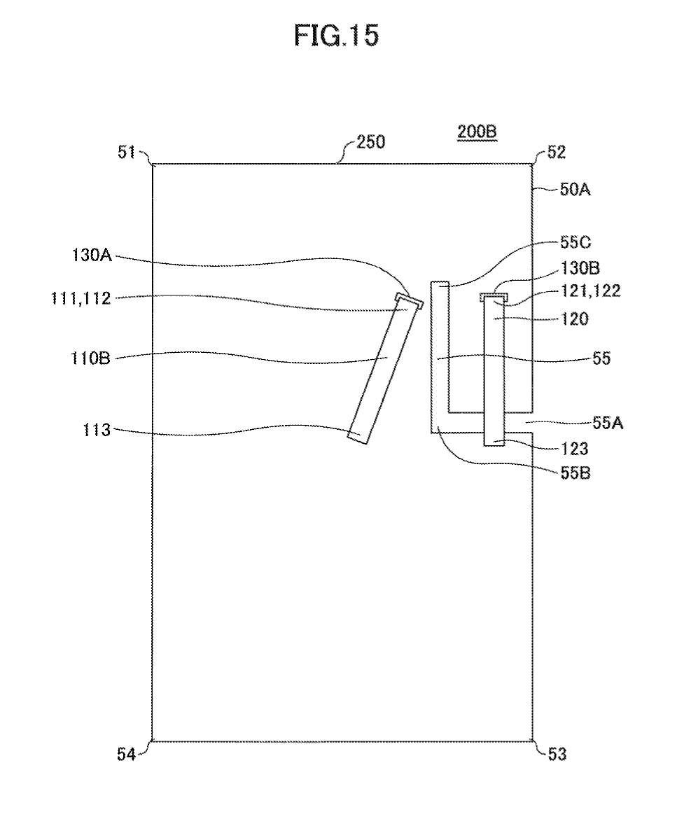

FIG. 14 and FIG. 15 are diagrams illustrating antenna apparatuses 200A and 200B according to variation examples of the second embodiment.

The antenna apparatus 200A that is illustrated in FIG. 14 is obtained by changing the antenna element 110 of the antenna apparatus 200 that is illustrated in FIG. 10 into an antenna element 110A. The antenna element 110A is provided on the negative side in the Y axis direction with respect to the section between the open end 55A and the bend part 55B of the slit 55.

The antenna element 110A is arranged such that the position of the antenna element 110A is equal to that of the antenna element 120 in the X axis direction. The feed point 111 and the bend part 112 are located on the positive side in the Y axis direction and the open end 113 is located on the negative side in the Y axis direction. With respect to the slit 55, the antenna element 110A is provided on the opposite side of an area surrounded by the slit 55 and the edge 50A.

Also in such an antenna apparatus 200A, because the antenna element 120 is coupled with the slit 55, the coupling between the antenna elements 110A and 120 is reduced similar to the antenna apparatus 200 that is illustrated in FIG. 10.

Note that such an arrangement is effective in a case where the antenna element 110A cannot be arranged next, to the antenna element 120 as in the antenna element 110 of the antenna apparatus 200 that is illustrated in FIG. 10, due to a relationship of an internal space of the housing 500A of the tablet computer 500 or the like.

Further, the antenna apparatus 200B that is illustrated in FIG. 15 is obtained by changing the antenna element 110 of the antenna apparatus 200 that is illustrated in FIG. 10 to an antenna element 110B. The antenna element 110B is obtained by changing the angle of the antenna element 110 that is illustrated in FIG. 10.

Also in such an antenna apparatus 200B, because the antenna element 120 is coupled with the slit 55, the coupling between the antenna elements 110B and 120 is reduced similar to the antenna apparatus 200 that is illustrated in FIG. 10.

Note that such an arrangement is effective in a case where the antenna element 110B cannot be arranged parallel to the antenna element 120 as in the antenna element 110 of the antenna apparatus 200 that is illustrated in FIG. 10, due to a relationship of an internal space of the housing 500A of the tablet computer 500 or the like.

### Third Embodiment

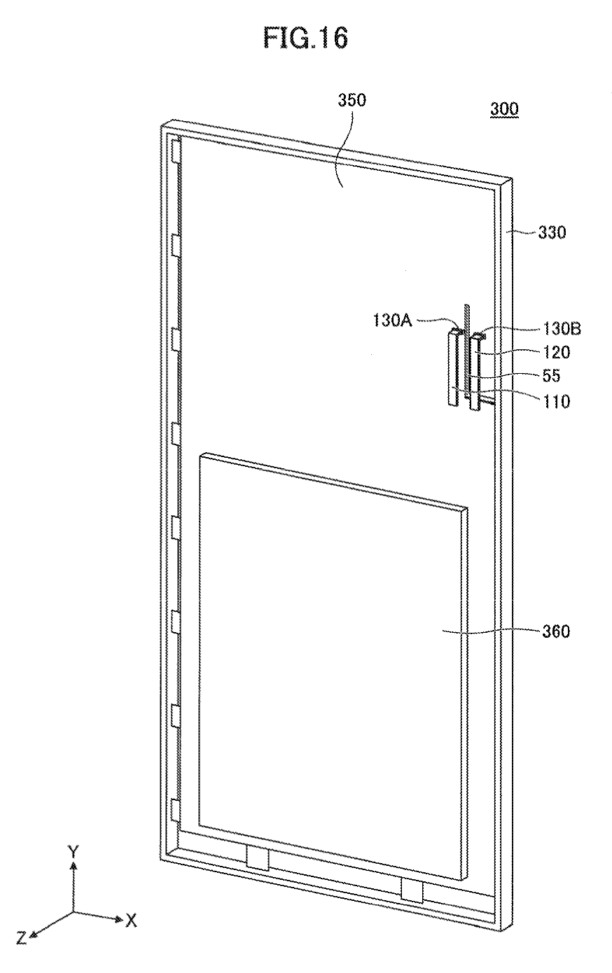

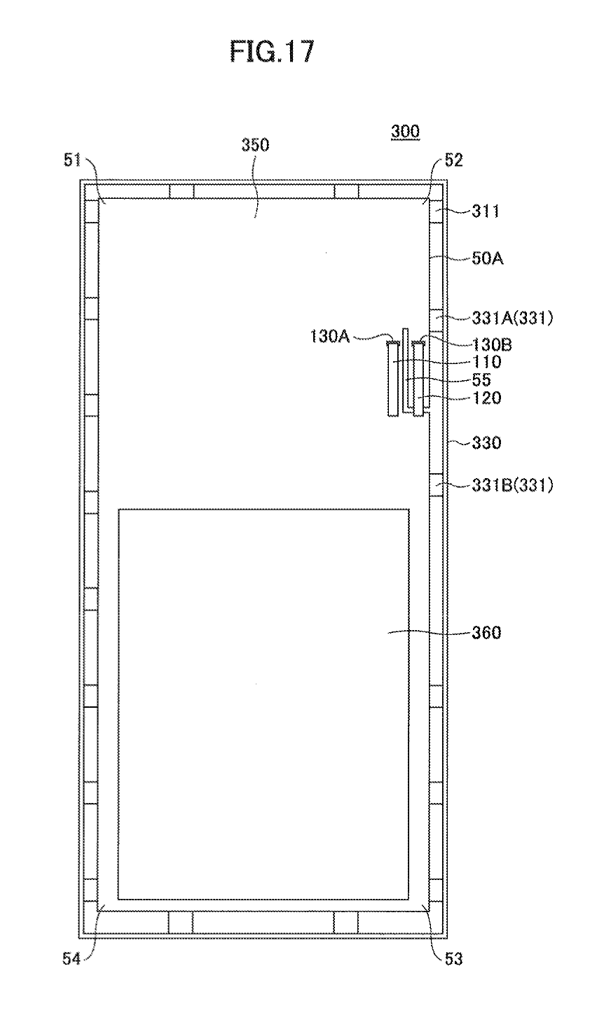

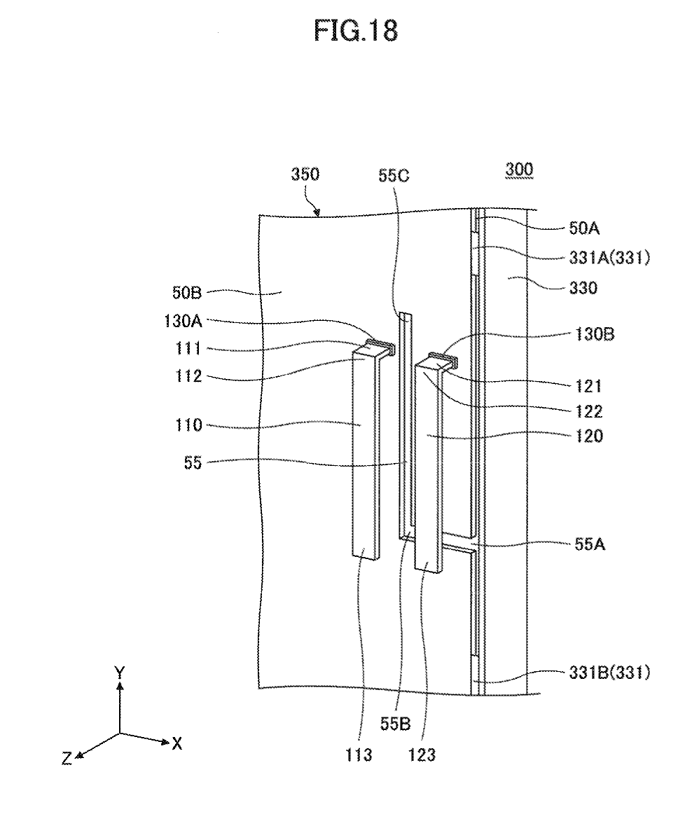

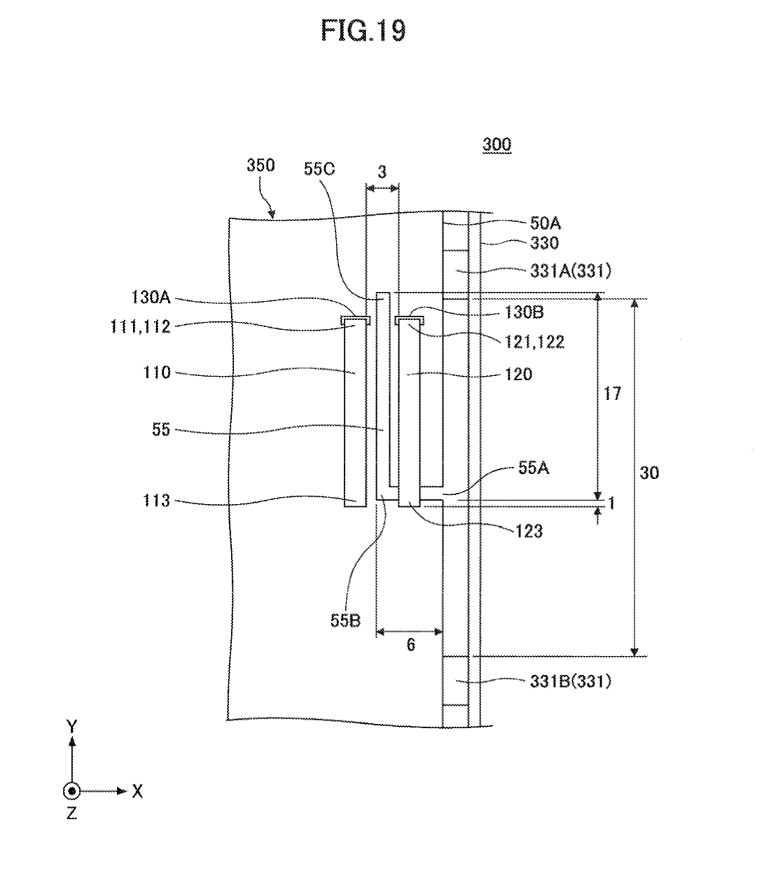

FIG. 16 and FIG. 17 are a perspective view and a plan view illustrating an antenna apparatus 300 according to a third embodiment. FIG. 18 is a perspective view enlarging a part of FIG. 16, and FIG. 19 is a plan view illustrating the enlarged part illustrated in FIG. 18.

The antenna apparatus 300 includes a ground plane 350, antenna elements 110 and 120, matching circuits 130A and 130B, and a metal plate 330. The antenna apparatus 300 is provided in the tablet computer 500 (see FIG. 1) that has a communication function.

The antenna apparatus 300 according to the third embodiment has a configuration obtained by replacing the ground plane 50 of the antenna apparatus 100 of the first embodiment with the ground plane 350 and attaching the metal plate 330 to the periphery of the ground plane 350.

Note that the ground plane 350 is similar to the ground plane 250 of the second embodiment, and has a configuration obtained by removing the frame part 56 from the ground plane 50 of the first embodiment. A battery 360 is arranged on the surface 50B side at the negative side in the Y axis direction of the ground plane 350. Other components of the antenna apparatus 300 are similar to those of the antenna apparatuses 100 and 200 of the first and second embodiments. Thus, the same reference numerals are given to the similar components and their descriptions are omitted as appropriate.

The metal plate 330 is a metal plate having a rectangular ring shape surrounding the periphery of the ground plane 350. The metal plate 330 is thin in the X axis direction and the Y axis direction and has a predetermined width in the Z axis direction. The metal plate 330 is coupled to the periphery of the ground plane 350 by 18 connection parts 331. Hence, the metal plate 330 is held at a ground potential. A part or the whole of the metal plate 330 may be exposed on a side surface of the housing 500A (see FIG. 1).

Among the 18 connection parts 331, the two connection parts 331 that are closest to the open end 55A of the slit 55 are referred to as connection parts 331A and 331B. The connection part 331A is located on the positive side in the Y axis direction with respect to the open end 55A and the connection part 331B is located on the negative side in the Y axis direction with respect to the open end 55A.

A section of the metal plate 330 between the connection parts 331A and 331B has a configuration similar to that of the frame part 56 that is illustrated in FIG. 3 and FIG. 4. Therefore, similarly to the antenna apparatus 100 of the first embodiment, in the antenna apparatus 300, an electric current flows in the section between the connection parts 331A and 331B of the metal plate 339, and the slit 55 and the antenna element 120 are coupled. Within the metal plate 330, at least the section between the connection parts 331A and 331B is an example of a protruding metal member.

Note that the dimensions of each part are as follows, for example. The dimensions described here are on the basis that the antenna elements 110 and 120 perform communication at 3.5 GHz.

The length of the antenna element 110 from the feed point 111 to the open end 113 via the bend part 112 is 15 mm, and the width of the antenna element 110 in the X axis direction is 2 mm, and the height of the antenna element 110 from the surface SOB of the ground plane 350 is 1.5 mm. The width of the slit 55 is 2 mm. The housing 500A (see FIG. 1) has a length in the X axis direction of 75.4 mm, a length in the Y axis direction of 156 mm, a thickness in the Z axis direction of 7.7 mm, and a relative permittivity of 3.

Further, as illustrated in FIG. 19, the interval between the antenna elements 110 and 120 in the X axis direction is 3 mm, the length between the open end 55A and the bend part 55B of the slit 55 is 6 mm, and the length between the bend part 55B and the end part 55C of the slit 55 is 17 mm. The length in the Y axis direction between the end in the Y axis direction of the section between the open end 55A and the bend part 55B of the slit 55 and the open end 113 of the antenna element 110 is 1 mm. The length of the section between the connection parts 331A and 331B of the metal plate 330 is 30 mm.

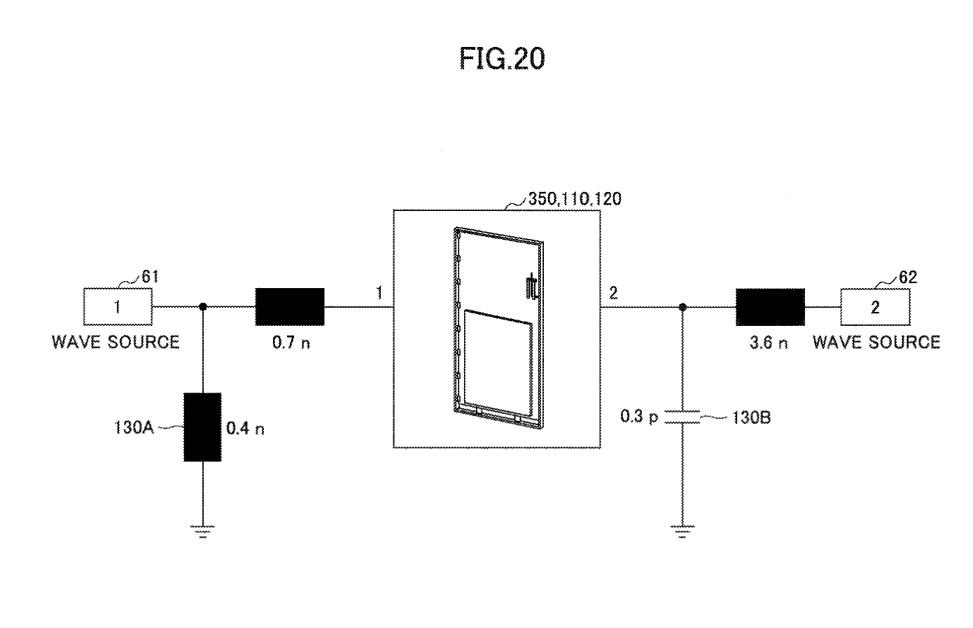

FIG. 20 is a diagram illustrating each parameter of a simulation model of the antenna apparatus 300. In FIG. 20, the ground plane 350 and the antenna elements 110 and 120 are simplified and illustrated as one block. Ports 1 and 2 are the feed points 111 and 121, respectively. Further, FIG. 20 illustrates inductors and a capacitor of the matching circuits 130A and 130B. Other configurations are similar to those in FIG. 7.

The matching circuit 130A is set to include an inductance (0.7 nH) that is inserted between the feed point 111 and the wave source 61 and an inductance (0.4 nH) that is inserted between, the ground plane 350 and a point branched from between the feed point 111 and the wave source 61.

Further, the matching circuit 130B is set to include an inductance (3.6 nH) that is inserted between the feed point 121 and the wave source 62 and a capacitor (0.3 pF) that is inserted between the ground plane 350 and a point branched from between the feed point 121 and the wave source 62.

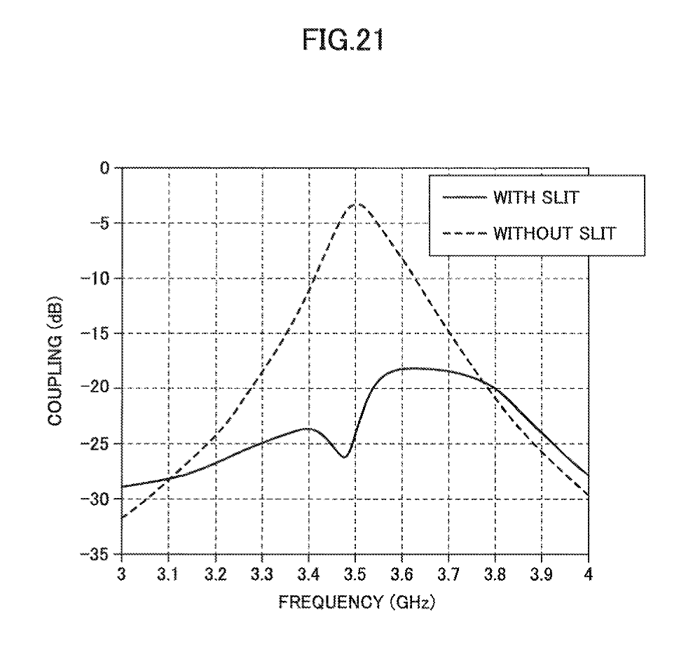

FIG. 21 is a diagram illustrating frequency characteristics of a coupling factor between the antenna elements 110 and 120 obtained by the simulation model that is illustrated in FIG. 20. The coupling factor between the antenna elements 110 and 120 is a S₂₁ parameter.

In FIG. 21, the horizontal axis represents the frequency and the vertical axis represents the value of the S₂₁ parameter (dB). Further, here, a coupling factor between antenna elements 110 and 120 in a simulation model without a slit 55 is also obtained for comparison. Note that the communication frequency of the antenna elements 110 and 120 (resonant frequency) is 3.5 GHz, for example.

In FIG. 21, as illustrated by the solid line, the coupling factor between the antenna elements 110 and 120 of the simulation model that includes the slit 55 is approximately −26.5 dB at 3.5 GHz, and as illustrated, by the broken line, the coupling factor between the antenna elements 110 and 120 of the simulation model that does not include the slit 55 is approximately −4 dB at 3.5 GHz. Thus, it is found that the coupling factor is significantly reduced by providing the slit 55 on the ground plane 350.

That is, it is found that the coupling fact car between the antenna elements 110 and 120 that are arranged side by side can be significantly reduced by providing the slit 55 that is coupled to the antenna element 120 and forming a rectangular loop by the edge 50A and the section between the connection parts 331A and 331B of the metal plate 330.

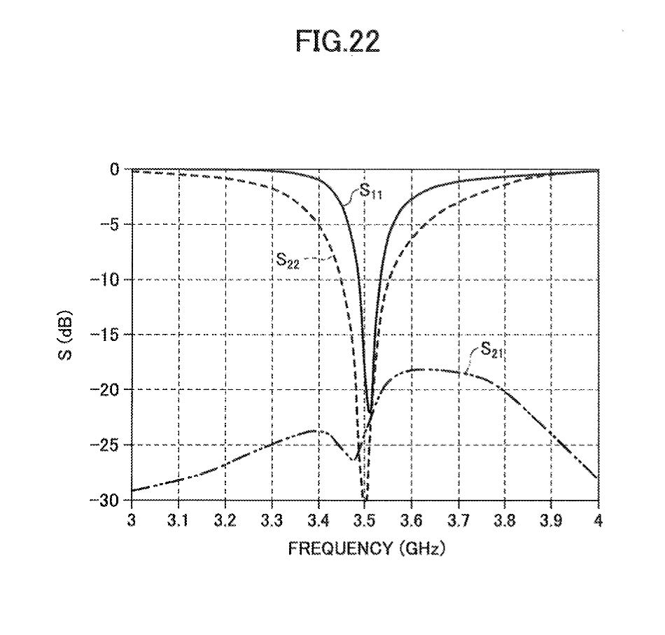

FIG. 22 is a diagram illustrating frequency characteristics of a coupling factor between the antenna elements 110 and 120 and reflection coefficients of the antenna elements 110 and 120 obtained by the simulation model that is illustrated in FIG. 20. The coupling factor between the antenna elements 110 and 120 is a S₂₁ parameter, and the reflection coefficients are S₁₁ and S₂₂ parameters.

The S₂₁ parameter is approximately −24 dB at 3.5 GHz, and it can be confirmed that the coupling between the antenna elements 110 and 120 is low. Further, the S₁₁ and S₂₂ parameters are approximately −22.5 dB and approximately −30 dB at 3.5 GHz, and it can be confirmed that the reflection of the antenna elements 110 and 120 is small.

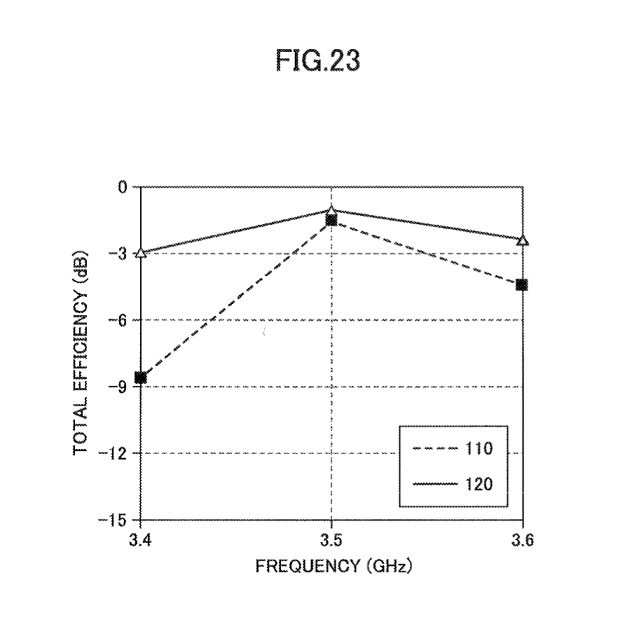

FIG. 23 is a diagram illustrating frequency characteristics of total efficiencies of the antenna elements 110 and 120 obtained by the simulation model that is illustrated in FIG. 20.

The total efficiency of the antenna element 110 is approximately −1.5 dB at 3.5 GHz and the total efficiency of the antenna element 120 is approximately −1.2 dB at 3.5 GHz, both of which are good values.

As described above, according to the third embodiment, the coupling between the antenna elements 119 and 120 that are arranged side by side can be reduced by providing the slit 55 formed into a L shape from the edge 50A of the ground plane 350, respectively arranging the antenna elements 110 and 120 on both sides with, respect to the slit 55, and causing the open end 123 side of the antenna element 120 to cross over the slit 55.

Therefore, it is possible to provide the antenna apparatus 300 and the tablet computer 500 in which the coupling between the antenna elements 110 and 120 is reduced.

Further, by providing the metal plate 330 on the ground plane 350, an electric current flows in the rectangular loop that is formed by the edge 50A and the section between the connection parts 331A and 331B of the metal plate 330. Thereby, it is possible to cause a large amount of electric current to flow in the antenna element 120, This also allows to reduce the coupling between the antenna elements 110 and 120.

Further, the reflection coefficients of the respective antenna elements 110 and 120 are sufficiently low and good values, and good values of the total efficiency are obtained. Therefore, it is possible to provide the antenna apparatus 300 in which the antenna elements 110 and 120 have preferable radiation characteristics and in which the coupling between the antenna elements 110 and 120 is reduced.

Note that in the embodiment described above, the metal plate 330 is a member having a rectangular ring shape surrounding the periphery of the ground plane 350. However, the metal plate 330 may be divided at the periphery of the ground plane 350. Alternatively, a part of the metal plate 330 may be configured to serve as an antenna element, or the metal plate 330 may be configured to serve as a part of an antenna element.

Although examples of the antenna apparatus and the electronic device according to the embodiments of the present invention have been described above, the present invention is not limited to the embodiments specifically disclosed and various variations and modifications may be made without departing from the scope of the present invention.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. An antenna apparatus comprising:
a ground plane having an edge, a first surface, and a slit, the slit extending from a slit open end provided on the edge to an inside first point in plan view, the slit bending at the first point to extend, along the edge, to a second point;
a first antenna element having a first feed point and a first open end, the first feed point being arranged, close to the first surface, at an opposite side of an area surrounded by the slit and the edge with respect to the slit in plan view, the first antenna element extending from the first feed point to a first bend part at a first height position with respect to the first surface, the first antenna element bending at the first bend part in a direction along the slit to extend to the first open end; and
a second antenna element having a second feed point and a second open end, the second feed point being arranged, close to the first surface, in the area surrounded by the slit and the edge with respect to the slit in plan view, the second antenna element extending from the second feed point to a second bend part at a second height position with respect to the first surface, the second antenna element bending at the second bend part in the direction along the slit to extend to the second open end, the second antenna element crossing, at a second open end side, the slit, in plan view.

2. The antenna apparatus according to claim 1,
wherein the first antenna element and the second antenna element are arranged along a section between the first point and the second point of the slit, and
wherein a portion of the second antenna element at the second open end side crosses a section between the slit open end and the first point of the slit.

3. The antenna apparatus according to claim 1,
wherein the first feed point and the second feed point are arranged side by side and a section between the first point and the second point of the slit is interposed between the first feed point and the second feed point,
wherein the first height position and the second height position are equal to each other, and
wherein a section from the first bend part to the first open end of the first antenna element is parallel to a section from the second bend part to the second open end of the second antenna element.

4. The antenna apparatus according to claim 1, further comprising:
a protruding metal member having a first end part and a second end part that are respectively connected to a first side and a second side with respect to the slit open end of the edge, the protruding metal member being provided to protrude, between the first end part and the second end part, with respect to the edge.

5. The antenna apparatus according to claim 4,
wherein the protruding metal member includes a first section, a second section, and a third section, the first section extending from the first end part to a third bend part in a direction away from the edge, the second section bending at the third bend part along the edge to extend to a fourth bend part, the third section bending at the fourth bend part towards the edge to extend to the second end part.

6. The antenna apparatus according to claim 4, wherein a length of a loop formed by the edge and the protruding metal member is either longer or shorter than an electrical length of a wavelength at a communication frequency of the second antenna element.

7. The antenna apparatus according to claim 1, wherein a length of the slit from the slit open end to the second point via the first point is either longer or shorter than a quarter length of an electrical length of a wavelength at a communication frequency of the second antenna element.

8. The antenna apparatus according to claim 1, wherein the first antenna element and the second antenna element are inverted-L or inverted-F antenna elements.

9. An electronic device comprising:
a housing; and
an antenna apparatus disposed in the housing,
wherein the antenna apparatus includes
a ground plane having an edge, a first surface, and a slit, the silt extending from a slit open end provided on the edge to an inside first point in plan view, the slit bending at the first point to extend, along the edge, to a second point;
a first antenna element having a first feed point and a first open end, the first feed point being arranged, close to the first surface, at an opposite side of an area surrounded by the slit and the edge with respect to the slit in plan view, the first antenna element extending from the first feed point to a first bend part at a first height position with respect to the first surface, the first antenna element bending at the first bend part in a direction along the slit to extend to the first open end; and
a second antenna element having a second feed point and a second open end, the second feed point being arranged, close to the first surface, in the area surrounded by the slit and the edge with respect to the slit in plan view, the second antenna element extending from the second feed point to a second bend part at a second height position with respect to the first surface, the second antenna element bending at the second bend part in the direction along the slit to extend to the second open end, the second antenna element crossing, at a second open end side, the slit in plan view.
